(19) United States
(12) Patent Application Publication
(10) Pub. No.: US 2014/0207973 A1
(43) Pub. Date: Jul. 24, 2014

(54) SYSTEMS AND METHODS FOR AUTO-CONFIGURING INSTALLABLE DEVICE OPTIONS IN A WINDOWS PRINT QUEUE

(71) Applicant: XEROX CORPORATION, Norwalk, CT (US)

(72) Inventors: Alan Kenneth Robertson, Rochester, NY (US); David Michael Chapin, Gresham, OR (US)

(73) Assignee: Xerox Corporation, Norwalk, CT (US)

(21) Appl. No.: 13/745,380

(22) Filed: Jan. 18, 2013

(51) Int. Cl. G06F 9/44

(52) U.S. Cl. CPC G06F 9/4411
USPC 710/8

(57) ABSTRACT

Embodiments relate to systems and methods for auto-configuring installable device options in a Windows™ print queue. Software and other resources are provided to enable print drivers based on the version 4 print architecture to perform auto-configuration of installable options for printing devices which do not support the protocols and/or queries required by the native means of auto-configuration supported by the Windows™ 8 operating system. A setup module can install tasks under the task scheduler including a task which is triggered by print queue related events, along with a polling task to detect printer device changes. These tasks can invoke a printer configuration module which in turn invokes two transient child processes to supply the print driver with printer configuration data in the expected native format used by the Windows™ 8 operating system.

### FIELD

The present teachings relate to systems and methods for auto-configuring installable device options in a Windows™ print queue, and more particularly, to platforms and techniques for invoking transient processes for generating configuration information for printers and other output devices on an event-triggered basis, using operating system resources.

### BACKGROUND

In the field of print driver architectures and platforms, printer manufacturers have long integrated print driver and related software for their particular output devices with commonly available computer operating systems, including the Windows™ family of operating systems. In versions of the Windows™ operating system up to and including the Windows™ 7 operating system, for example, it was possible for original equipment manufacturers (OEMs) to develop executable code as part of a print driver which would query a networked printing device and retrieve data describing the configuration of the device via any protocol, including proprietary protocols. The print driver could then use these data to automatically configure itself based on the capabilities and optional equipment installed on that particular printing device. That code was executed using a callback mechanism and ran with administrative privileges.

However, starting with the Windows™ 8 operating system, a new 4^{th} generation print architecture was introduced. The callback mechanism to allow a print driver to query device configuration data was eliminated. The only remaining mechanism requires the printing device to support specific protocols. Print drivers declare query strings in data files and the operating system, not the print driver executes the queries. Data files are then also used to map query results to installable option states in order to configure the print driver automatically.

Many printing devices do not support the specific protocols or queries necessary to enable automatic configuration in 4^{th} generation print drivers for Windows™ 8 and future versions of the operating system. System administrators would need to manually configure the 4^{th} generation print driver for every printing device that does not support the specific required protocols and queries even if 3^{rd} generation print driver for the same printing device could successfully configure itself.

It may be desirable to provide methods and systems for auto-configuring installable device options in a Windows™ 8 or later print queue, in which printer driver, print queue, and other software or resources can be accessed and used to generate output on printers and other devices which do not support the specific required protocols to enable automatic configuration under the Microsoft Windows™ 8 or later operating system.

### DESCRIPTION OF DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall network environment in which in systems and methods for auto-configuring installable device options in a Windows™ 8 print queue can be implemented, according to various embodiments;

FIG. 2 illustrates an architecture for implementing systems and methods for auto-configuring installable device options in a Windows™ 8 print queue, according to various embodiments;

FIG. 3 illustrates a flowchart of print queue and related output processing that can be used in implementations of systems and methods for auto-configuring installable device options in a Windows™ 8 print queue, according to various aspects;

FIG. 4 illustrates a flowchart of print queue and related output processing that can be used in implementations of systems and methods for auto-configuring installable device options in a Windows™ 8 print queue, according to various aspects in additional regards; and

FIG. 5 illustrates a flowchart of print queue and related output processing that can be used in implementations of systems and methods for auto-configuring installable device options in a Windows™ 8 print queue, according to various aspects in still further regards.

### DESCRIPTION OF EMBODIMENTS

Embodiments of the present teachings relate to systems and methods for auto-configuring installable device options in a Windows™ 8 print queue. More particularly, embodiments relate to platforms and techniques for establishing and executing print queue and related output operations under the Windows™ 8 and later-developed operating systems, in which operating system resources are invoked to allow the monitoring of print queue and other events via the operating system, itself. Once a print queue event is detected, a print configuration module and associated processes and logic can be invoked to execute code to query the device and obtain configuration data via any useful protocol, without a need for the output device itself to be configured to support Windows™ 8-specific standards and protocols.

Reference will now be made in detail to exemplary embodiments of the present teachings, which are illustrated in the accompanying drawings. Where possible the same reference numbers will be used throughout the drawings to refer to the same or like parts.

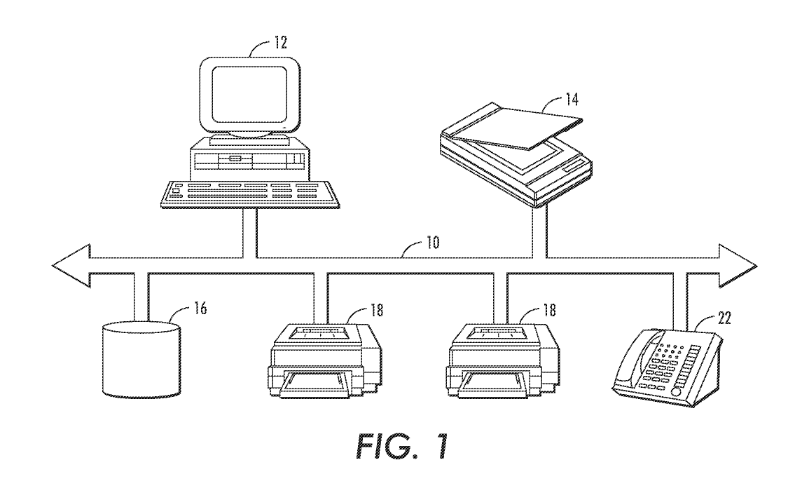

FIG. 1 illustrates an overall environment in which systems and methods for auto-configuring installable device options in a Windows print queue can operate, according to aspects. A network bus 10, which may be of any type known in the art, such as Ethernet or Token-Ring, interconnects a number of computers and peripherals. For example, on network 10 there would be typically any number of personal computers such as 12, scanners such as 14, shared memories such as 16, and of course printers such as 18 and 20. The network 10 may further interconnect a fax machine 22, which in turn connects with a standard telephone network. What is important is that the various computers and peripherals can interact to perform various document services, including to generate reliable print queues using the bi-directional query structure imposed by the Windows™ 8 and later operating systems for print and other output services.

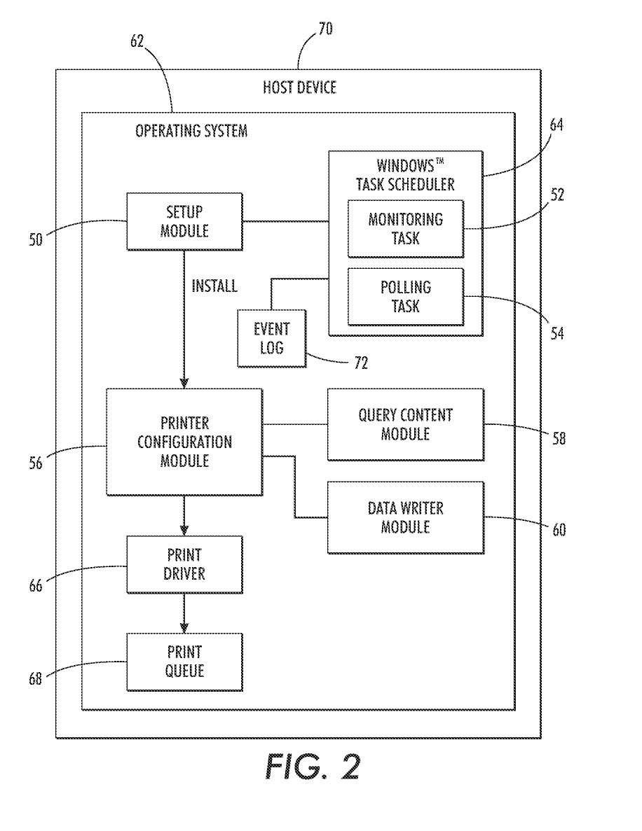

More specifically and as for instance illustrated in FIG. 2, a host device 70 can host hardware, software, modules, logic, services, and/or other resources to support and manage output operations to a printer or other device, running under an operating system 62 configured to operate on a query model to discover installable print options. According to implementations, the operating system 62 can be or include the Windows™ 8 or later operating systems, which in general use an interrogation model to discover and install features related to printers, multi-function devices, or other output hardware or machines. In implementations as shown, a number of resources can operate in the host device 70 in conjunction with or under control of the operating system 62. The host device 70 can for instance be or include a desktop or laptop computer, or a print-enabled mobile device such as a smartphone. In implementations, the host device 70 can be or include a print server, for instance a print server installed on a local area network (LAN) or other network. In implementations, the host device 70 can be or include a printer or other output device, itself. In still further implementations, the host device 70 can be implemented as a logical entity instantiated in a cloud-based network, and/or other hardware, software, and/or other networks or entities.

In aspects, a setup module 50 can be installed under the operating system 62 to install a set of software, resources, and settings related to printing and other output operations. The setup module 50 can install tasks or processes including a monitoring task 52 and a polling task 54, which can operate in conjunction with a task scheduler 64. The task scheduler 64 can be a part of the operating system 62, and operate to monitor various events, threads, applications, and/or processes executing under the operating system 62 on the host device 70. According to aspects, either or both of the monitoring task 52 and the polling task 54 can be instantiated as process having an administrative level of privilege. In aspects, the setup module 50 can also instruct or cause the operating system 62 to begin logging output-related events to an event log 72, including the establishment or updating of a print queue 68 (or queues), the installation or updating of a printer or other output device, and/or other events. In aspects, the operating system 62 can install and manage one or more print driver 66, using which print jobs and other output can be directed to the print queue 68.

The monitoring task 52 can be configured to monitor the event log 72 to detect the occurrence of a print-related task, and/or other output activity. When a print-related task, such as the addition of a print job to the print queue 68, or other event occurs, the monitoring task 52 can detect that event in the event log 72 and perform a set of additional tasks to automatically configure the installable options for the print queue 68 based on the actual current configuration of the printer or other output device. In aspects, the polling task 54 can operate to perform query operations by interrogating connected printers or other devices, but can do using a predetermined time interval, rather than on an event-triggered basis like the monitoring task 52. In aspects, the polling task 54 can be configured to query connected printers or other devices every 4 hours, 6 hours, 8 hours, I day, and/or other periods of time, so that printers and other devices which are attached, detached, and/or updated can have their configuration data regularly refreshed so that users can utilize those devices conveniently, without having to manually update the configuration options.

Once a print queue-related event is detected via the event log 72, the monitoring task 52 can launch the print configuration module 56. The printer configuration module 56 manages relatively short-lived or transient child processes to automatically configure the print driver 66. Each processes launched by or under the printer configuration module 56 can run with the lowest possible privileges under the operating system 62, to minimize security risks. When the host device 70 comprises a print server, the host device 70 can provide BiDi data exchange capabilities for all connected clients.

In general, the use of BiDi data communications allows the printer configuration module 56 to manage and support a number of print-related data and resources, including installable options and/or auto-configuration data set directly in Windows™ 8 format so that the core drivers contained in Windows™ 8 and/or later operating systems will correctly recognize installable output options, transparently. Those options can include features or options such as, for example, stapling, punching, or folding, with details regarding the number, type, location, etc. of each of those paper handling options for each.

The printer configuration module 56 can invoke or instantiate further tasks, logic, or processes to manage print or other output events, on an event-driven basis, for instance executing code using any useful protocol to query a printing device for configuration information. The further tasks or processes invoked by the printer configuration module 56, as illustrated, can be or include a query component module 58 and a data writer module 60. The data writer module 60 can be configured to store the processed results of queries in the manner established in the Windows™ 8 and later family of operating systems so that the print driver will respond as if it has been configured directly by the native method supported by the operating system. The printer configuration module 56 can manage the polling interval and periodically launch the query component module 58 and data writer module 60 as transient child processes, as noted, as well as periodically check for changes such as changes in port assignments, the IP address or host name of output devices, or others.

Once launched, the query component module 58 can, more particularly, access any connected network to which the host device 70 is connected, running as a network service. In aspects, the query component module 58 does not require administrator privileges, or even user-level privileges. The query component module 58 can access and interact with dynamic link libraries (DLLs) and other resources designed to query printing device configuration under pre-Windows™ 8 operating systems in the Windows™ family of operating systems, without necessary modifications to those resources. Those DLLs and other resources can be used to extract and read printer configuration data and/or auto-configuration data for other types of output devices, and report that configuration data to the operating system 62 using standard or proprietary BiDi query structures supported by the printing device. Those and related operations performed by the query component module 58 can include parsing of data files to obtain the attribute and value names for all installable options supported by the printing device. The query component module 58 can query the requested BiDi data for the print queue 68 or other queues specified when the printer configuration module 56 launches the query component module 58. The query component module 58 can likewise convert any legacy data formats into a standard format, such as XML (extensible markup language)-based formats, or others. Query results developed by the query component module 58 can be written to XML or other files on disk or other memory or media. Once the configuration data needed to populate the print queue 68 is acquired, the query component module 58 can exit or terminate promptly as a process under the operating system 62, to avoid processor overhead and enhance security of the operating system 62. In implementations, the print driver module 66 can be configured to apply installable option constraints or rules, for instance, rules which prevent an A3-sized print job from being loaded into print queue 68 for a printer which is not capable of handling that size stock. Other rules, parameters, constraints, or logic can be used.

In addition to the query component module 58, the printer configuration module 56 can invoke the data writer module 60 to perform data output or writing tasks associated with the print queue 68. According to aspects, the data writer module 60 can execute with administrative privileges, and write to a registry key in operating system 62 such as the “PrinterDriverData” registry key in Windows™ 8, and/or to the Queue Property Bag associated with the print queue 68 in Windows™ 8. In connection with writing operations, the data writer module 60 can parse the auto-configuration data from the XML or other files created by the query component module 58 while performing query operations. The data writer module 60 can use that data to configure the print queue 68 using that data, for instance by writing corresponding attribute values to the registry of Windows™ 8 or other operating system. It may be noted that as used herein, a “module” can refer to one or more applications, utilities, threads, processes, services, and/or other logic, or processors or other hardware configured to execute that logic, and/or other resources. A “module” can likewise in cases be discrete, or combined with other modules or resources.

After performing those or other writing or output operations, the data writer module 60 can likewise exit or terminate promptly, both to minimize processor load and reduce security risks. The printer configuration module 56, query component module 58, and data writer module 60 thus cooperate to configure the print driver by writing data to the same locations and in the same format as the native BiDi query architecture of Windows™ 8 would do so that the source of these data is transparent to the print driver.

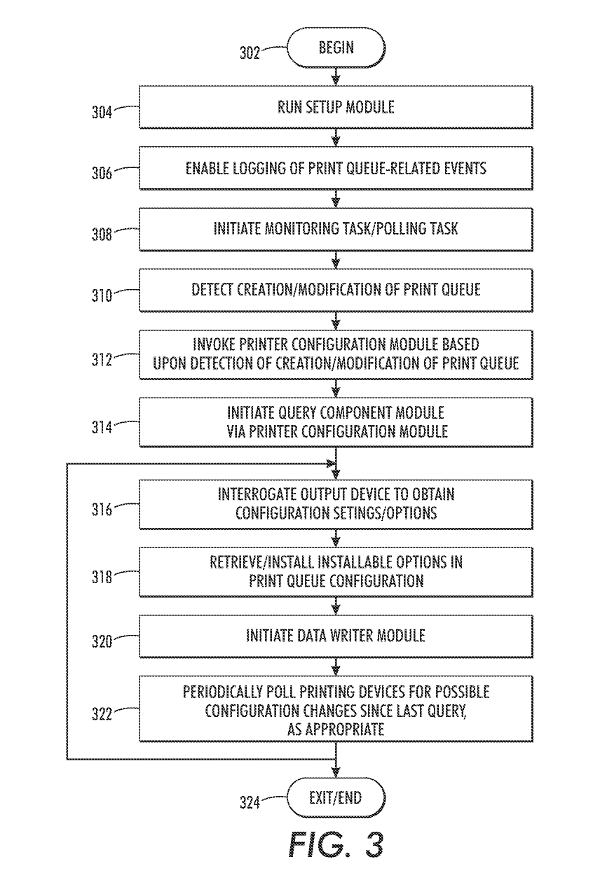

FIG. 3 illustrates a flowchart of print queue and other processing that can be performed in systems and methods for auto-configuring installable device options in a Windows™ print queue, according to aspects. In 302, processing can begin. In 304, the setup module 50 can be run, for instance by a systems administrator who pushes the setup module to laptops, desktops, smartphones, and/or other devices on a local or wide area network. In 306, logging of print queue-related events can be enabled by the setup module 50 to for instance record or log those events to an event log 72 maintained by the operating system 62, such as the Windows™ 8 or later operating systems. In 308, the monitoring task 52 and polling task 54 tasks can be created under the task scheduler 64 by the setup module 50, to perform monitoring and/or polling operations as described herein.

In 310, the monitoring task 52 can detect the creation, modification, and/or other status of the print queue 68 installed or operating on the host device 70. In aspects, activity related to the print queue 68 can be detected by detecting the entry of events in the event log 72 of the operating system 62. In 312, the printer configuration module 56 can be invoked via the monitoring task 52 and/or other logic based upon the detection of a creation or modification event related to the print queue 68. In 314, the query component module 58 can be initiated via the printer configuration module 56, to execute as relatively short-term or ad hoc tasks.

In 316, the query component module 58 can interrogate the output device to obtain configuration settings, values, and/or options. In 318, the query component module 58 and/or data writer module 60 can retrieve, qualify, and/or install one or more installable options in the configuration of the print queue 68, such as to specify that the printing device has the capability to staple print jobs. In 320, the data writer module 60 can be invoked and/or initiated. In 322, the data writer module 60 and/or related logic can periodically poll any attached printing devices or other output devices for possible configuration changes since the last query, as appropriate. If the polling of 322 detects configuration changes, processing can return to 316. If the polling of 322 does not detect configuration changes, processing can proceed to 324 to repeat, return to a prior processing point, jump to a further processing point, exit, and/or end.

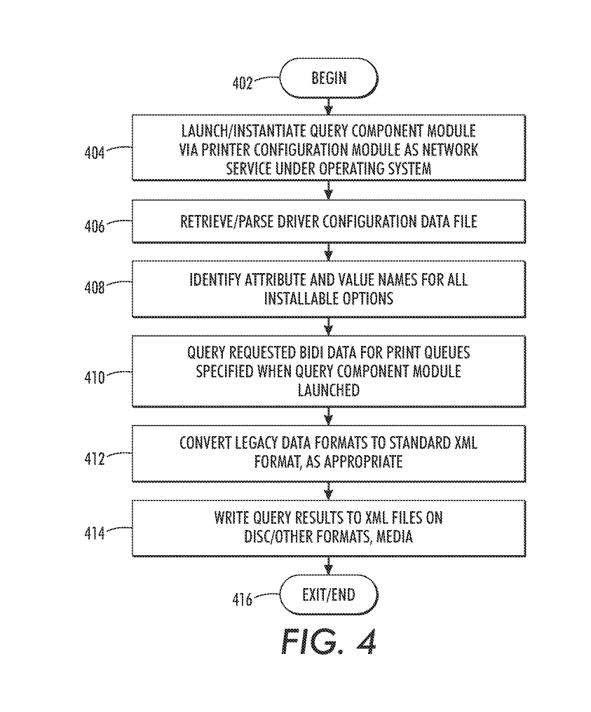

FIG. 4 illustrates a flowchart of print queue and other processing that can be performed in systems and methods for auto-configuring installable device options in a Windows™ print queue, according to further aspects including operation of the query component module 58. In 402, processing can begin. In 404, the query component module 58 can be launched or instantiated via the printer configuration module 56 as a network service under the operating system 62, such as the Windows™ 8 or later operating system. In 406, the query component module 58 can retrieve and/or parse the driver configuration data file for the attached printer or other output device with which the host device 70 is communicating. In 408, the query component module 58 can identify attribute and value names for all installable options for the printer or other output device. In 410, the query component module 58 can query for the BiDi data requested by the operating system 62 for the subject print queue 68 (or queues) specified when the query component module 58 is launched. In 412, the query component module 58 can convert legacy data formats to standard XML or other formats compatible with BiDi data, as appropriate. In 414, the query component module 58 can write the query results to XML files or other standard data formats to a disk, and/or other memory or media for subsequent processing by the data writer module 60. In 416, processing can repeat, return to a prior processing point, jump to a further processing point, exit, and/or end.

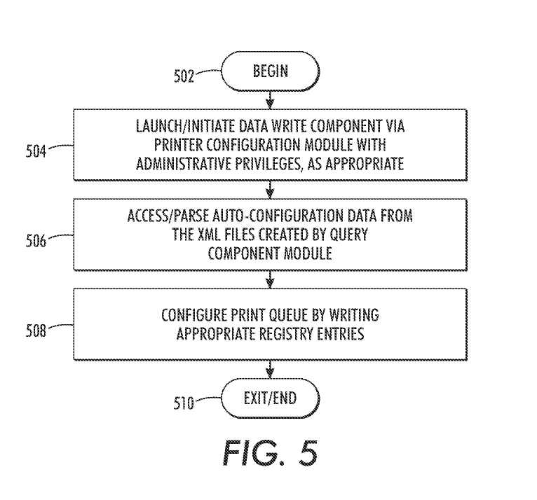

FIG. 5 illustrates a flowchart of print queue and other processing that can be performed in systems and methods for auto-configuring installable device options in a Windows™ print queue, according to further aspects including operation of the data writer module 60. In 502, processing can begin. In 504, the data writer module 60 can be launched and/or initiated via the printer configuration module 56 with administrative privileges under the operating system 62, such as the Windows™ 8 or later operating systems. In 506, the data writer module 60 can access and/or parse the auto-configuration data for the printer or other output device associated with the print queue 68, as appropriate. In 508, the data writer module 60 can configure, establish, and/or update the print queue 68 by writing appropriate registry entries to the registry of the operating system 62, such as the Windows™ 8 or later operating system. In 510, processing can repeat, return to a prior processing point, jump to a further processing point, exit, and/or end.

It will be appreciated that while various processing activity, logical decisions, and/or other operations illustrated in FIGS. 3-5 or elsewhere have been described as taking place in steps, that two or more of various of those operations or activities can be combined into one operation or activity, and that any one or more of those operations or activities can be divided into two or more operations or activities. Moreover, while those various operations or activities have been illustrated and described as occurring in a certain order, it will be appreciated that in implementations, those same and/or other operations or activities can take place in a different order or orders. It will likewise be understood that indicated reference numbers in connection with the various illustrated steps are intended for reference only, and are not meant to necessarily imply dependencies, precedence, and/or orders between steps, or that steps can not be rearranged or reordered. Further, while various operations or activities have been described as being carried out by certain hardware, software, service, and/or other resources, it will be appreciated that in implementations, the same activities and/or operations can be carried out by other hardware, software, service, and/or other resources, and/or combinations of the same.

It will likewise be appreciated that the foregoing description is illustrative, and variations in configuration and implementation may occur to persons skilled in the art. For example, while embodiments have been described in which the output delivered to the print queue consists of a printed page, in implementations, the output can take other forms such as a facsimile transmission page, output from a copier or multi-function device, or other output. Similarly, while embodiments have been described in which a print queue is built in a host device such as a print server, in implementations, the print queue can be hosted in other devices or locations, such as a laptop or personal computer, a smartphone or other mobile device, an application or service running in a local or remote network and/or in a cloud network, or others.

Further, while implementations have been described which incorporate a printer configuration module 56, query module 58, data writer module 60, and other modules, logic, and/or services as distinct units, in implementations, any one or more of those modules or related logic can be combined into one or more other modules, logic, and/or services. Likewise, while implementations have been described which incorporate a printer configuration module 56, query module 58, data writer module 60, and other modules, logic, and/or services as individual units, in implementations, those modules or related logic can be divided into two or more other internal or external modules, software logic, and/or services. Other resources described as singular or integrated can in embodiments be plural or distributed, and resources described as multiple or distributed can in embodiments be combined. The scope of the present teachings is accordingly intended to be limited only by the following claims.

What is claimed is:

1. A method of managing a print queue in the Windows™ 8 environment, comprising:
using the Windows™ Task Scheduler to monitor an event log to detect the creation or modification of a print queue;
initiating configuration logic based on the detection or modification of the print queue;
invoking, via the configuration logic, query logic to query at least one output device for configuration data in response to the detection of the creation or modification of the print queue; and
configuring the print queue based on the configuration data received from the at least one output device based on the query.

2. The method of claim 1, wherein the event log comprises a Windows™ 8 event log enabled as an “Applications and Services Logs->Microsoft->Windows™->PrintService” event log.

3. The method of claim 2, further comprising activating the “Applications and Services Logs->Microsoft->Windows™->PrintService” event log via an installation module.

4. The method of claim 1, wherein invoking the configuration logic further comprises invoking at least—
a bidirectional query component, and
a bidirectional data writer component,
based on the detection of the creation or modification of the print queue.

5. The method of claim 4, wherein the bidirectional query component executes as a network service under the Windows™ 8 environment.

6. The method of claim 5, wherein the bidirectional query component is configured to query installable option data from the output device using any compatible standard or proprietary protocol.

7. The method of claim 1, wherein the bidirectional data writer component processes the installable option data in Windows™ 8 format, and configures the print queue based on the installable option data.

8. The method of claim 7, wherein the configuration of the print queue is performed by the bidirectional data writer component.

9. The method of claim 7, wherein the installable option data comprises at least one of—
installed or enabled optional hardware or software modules and capabilities,
job finishing capabilities comprising at least one of stapling, hole punching, or folding,
paper handling specifications,
paper size specifications,
print orientation specifications,
print output type specifications, or
print resolution specifications.

10. The method of claim 4, wherein the bidirectional data writer component is configured to write at least a portion of the configuration data to persistent storage.

11. The method of claim 10, wherein the persistent storage comprises at least one of—
a registry key in Windows™ 8, or
a queue property bag in Windows™ 8.

12. A system, comprising:
an interface to an output device; and
a processor, communicating with the output device via the interface, the processor being configured to—
use the Windows™ Task Scheduler to monitor an event log to detect the creation or modification of a print queue,
initiate configuration logic based on the detection or modification of the print queue,
invoke, via the configuration logic, query logic to query at least one output device for configuration data in response to the detection of the creation or modification of the print queue, and
configure the print queue based on the configuration data received from the at least one output device based on the query.

13. The system of claim 12, wherein the event log comprises a Windows™ 8 event log enabled as an “Applications and Services Logs->Microsoft->Windows™->PrintService” event log.

14. The system of claim 13, further comprising activating the “Applications and Services Logs->Microsoft->Windows™->PrintService” event log via an installation module.

15. The system of claim 12, wherein invoking the configuration module further comprises invoking at least—
a bidirectional query component, and
a bidirectional data writer component,
based on the detection of the creation or modification of the print queue.

16. The system of claim 15, wherein the bidirectional query component executes as a network service under the Windows™ 8 environment.

17. The system of claim 16, wherein the bidirectional query component is configured to query installable option data from the output device using any compatible standard or proprietary protocol.

18. The system of claim 12, wherein the bidirectional data writer component processes the installable option data in Windows™ 8 format, and configures the print queue based on the installable option data.

19. The system of claim 18, wherein the installable option data comprises at least one of—
installed or enabled optional hardware or software modules and capabilities,
job finishing capabilities comprising at least one of stapling, hole punching, or folding,
paper handling specifications,
paper size specifications,
print orientation specifications,
print output type specifications, or
print resolution specifications.

20. The system of claim 15, wherein the bidirectional data writer component is configured to write at least a portion of the configuration data to persistent storage.
